(19) United States
(12) Patent Application Publication
(10) Pub. No.: US 2017/0356210 A1
(43) Pub. Date: Dec. 14, 2017

(54) ADAPTABLE NET

(71) Applicant: Hemant Kurani, Riverside, CA (US)

(72) Inventor: Hemant Kurani, Riverside, CA (US)

(21) Appl. No.: 15/619,022

(22) Filed: Jun. 9, 2017

Related U.S. Application Data
(60) Provisional application No. 62/349,568, filed on Jun. 13, 2016.

(51) Int. Cl. E04H 4/16; B01D 35/02; C02F 1/00; B01D 35/28; C02F 103/42

(52) U.S. Cl. CPC E04H 4/1609; C02F 1/001; B01D 35/28; B01D 35/02; B01D 2201/40; C02F 2103/42; C02F 2201/004

(57) ABSTRACT

An apparatus for collecting debris includes a frame having a connector configured to attach to a pole. The frame includes a plurality of frame rods each designed to be removably connected to at least one other frame rod via a tongue-and-groove feature such that the plurality of frame rods define an opening when connected together. The apparatus further includes a netting designed to be removably connected to the frame and to substantially fill the opening defined by the plurality of frame rods.

### CROSS REFERENCE TO RELATED APPLICATIONS

This application claims the benefit and priority of U.S. Provisional Application No. 62/349,568, entitled “Adaptable Net,” filed on Jun. 13, 2016, the entire contents of which are hereby incorporated by reference herein.

### BACKGROUND

### Field

The present disclosure relates to a modular net for use with pool equipment and, more particularly, to a modular net having multiple pieces removably coupled together.

### Description of the Related Art

Uncovered swimming pools can undesirably collect debris, such as leaves, insects and dirt, from the environment. Pool owners may use various types of nets, called pool rakes or pool skimmers, to remove such debris from swimming pools. The different types of nets may each be advantageous in different situations. For example, pool rakes may have a deeper net and may be best suited for collecting debris from a bottom of the pool. Pool skimmers, on the other hand, may have a shallower net and may be best suited for collecting debris from a top of the pool.

With the advent of online shopping, individuals are purchasing more and more items from the Internet. Such items are typically stored in a warehouse and then shipped to the customer upon receipt of the order. The cost of shipping an item may vary based on the size of the item and the weight of the item. Pool nets may be relatively large in size. In that regard, the cost for shipping a pool net may be relatively high.

Thus, there is a need for pool nets that may be shipped in relatively small packaging in order to reduce delivery costs.

### SUMMARY

Described herein is an apparatus for collecting debris. The apparatus includes a frame having a connector configured to attach to a pole. The frame includes a plurality of frame rods each designed to be removably connected to at least one other frame rod via a tongue-and-groove feature such that the plurality of frame rods define an opening when connected together. The apparatus further includes a netting designed to be removably connected to the frame and to substantially fill the opening defined by the plurality of frame rods.

Also described is an apparatus to be attached to a pole for removing debris from a swimming pool. The apparatus includes at least two frame rods defining an opening therebetween and including a first frame rod and a second frame rod each having a distal end distal to the pole and a proximal end proximal to the pole. The apparatus further includes a first connector adapted to attach the first frame rod and the second frame rod to each other at the proximal end and to attach the first frame rod and the second frame rod to the pole. The apparatus further includes a second connector adapted to attach the first frame rod and the second frame rod to each other at the distal end. The apparatus further includes a netting adapted to be coupled to at least one of the first frame rod or the second frame rod.

Also described is an apparatus for collecting debris. The apparatus includes a frame having a pole connector for coupling to a pole and having a plurality of frame rods each designed to be removably connected to at least one other frame rod such that the plurality of frame rods define an opening when connected together. The apparatus further includes at least one frame connector designed to attach at least a first frame rod to at least a second frame rod. The apparatus further includes a netting designed to be removably connected to the frame and to substantially fill the opening defined by the plurality of frame rods.

### BRIEF DESCRIPTION OF THE DRAWINGS

The exact nature of this invention, as well as the objects and advantages thereof, will become readily apparent upon consideration of the following specification in conjunction with the accompanying drawings in which like reference numerals designate like parts throughout the figures thereof and wherein:

FIG. 1 illustrates a net apparatus according to an embodiment of the present disclosure;

FIG. 2 illustrates different snap connectors which may be utilized in any net apparatus according to various embodiments of the present disclosure;

FIG. 3 illustrates a net apparatus that uses an adaptable first connector according to an embodiment of the present disclosure;

FIG. 4 illustrates a portion of the net apparatus of FIG. 3 that includes a hinge connector between frame rods according to an embodiment of the present disclosure;

FIG. 5 illustrates a net apparatus that utilizes a hinge connector according to an embodiment of the present disclosure;

FIG. 6 illustrates a net apparatus that includes a bracket connector according to an embodiment of the present disclosure;

FIG. 7 illustrates a modular net apparatus that utilizes multiple frame rods according to an embodiment of the present disclosure;

FIG. 8 illustrates an attachment adapted to provide a beveled edge to a net apparatus according to an embodiment of the present disclosure;

FIG. 9 illustrates a net apparatus including multiple frame rods and multiple hinge connectors according to an embodiment of the present disclosure;

FIG. 10 illustrates exemplary lever lock designs for attaching two frame rods of a net apparatus together according to an embodiment of the present disclosure;

FIG. 11 illustrates a net apparatus having a frame that forms a semicircular shape according to an embodiment of the present disclosure;

FIG. 12 illustrates a net apparatus having a frame with multiple slots for connection to a net frame of a netting according to an embodiment of the present disclosure;

FIG. 13 illustrates a connection between two frame rods of the net apparatus of FIG. 12 according to an embodiment of the present disclosure;

FIG. 14 illustrates a connection between two frame rods of the net apparatus of FIG. 12 according to an embodiment of the present disclosure;

FIG. 15 illustrates a netting having a net frame and a net for use with the net apparatus of FIG. 12 according to an embodiment of the present disclosure;

FIG. 16 is an enlarged view of a portion of the netting of FIG. 15 that includes tabs for connecting to the frame of FIG. 12 according to an embodiment of the present disclosure;

FIG. 17 illustrates a modular net apparatus having a frame with multiple frame rods and an oval shape according to an embodiment of the present disclosure;

FIG. 18 illustrates a net apparatus having angled and straight frame rods according to an embodiment of the present disclosure;

FIG. 19 illustrates frame rods and a frame connector of a modular net apparatus according to an embodiment of the present disclosure;

FIG. 20 illustrates a net frame for use with the modular net apparatus of FIG. 19 according to an embodiment of the present disclosure; and

FIG. 21 illustrates a net apparatus having a plurality of angled connectors and a plurality of equal-length frame rods according to an embodiment of the present disclosure.

### DETAILED DESCRIPTION OF THE PREFERRED EMBODIMENTS

Exemplary embodiments of a net will now be described in detail. These embodiments describe various features and functionality of the net. When used herein, the net may refer to any device with a handle and netting used to collect debris, including fishing nets, leaf or pool skimmers, leaf or pool rakes, or the like.

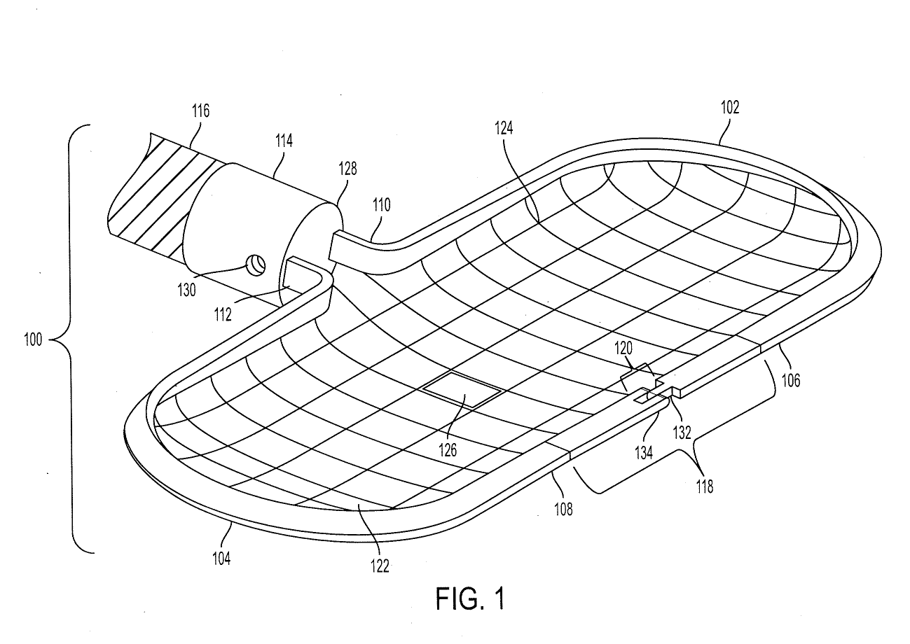

FIG. 1 illustrates an embodiment of a net apparatus 100. The net apparatus 100 includes a first frame rod 102 and a second frame rod 104. The first frame rod 102 includes a distal end 106 and a proximal end 110. The second frame rod 104 includes a distal end 108 and a proximal end 112. A first connector 114 is used to attach the proximal end 110 of the first frame rod 102 to the proximal end 112 of the second frame rod 104. The first connector 114 also attaches the first and the second frame rods 102, 104 to a pole 116. A second connector 118 is also included that is adapted to attach the distal end 108 of the first frame rod 102 to the distal end 108 of the second frame rod 104. The second connector 118 may include a hinge 120 that allows the first frame rod 102 to substantially overlay the second frame rod 104 for storage or shipping.

The first and the second frame rods 102, 104 can be formed from a material such as a metal, plastic, rubber, wood, composite, etc. The frame rods 102, 104 can be interchangeable, such that if a user is using plastic frame rods 102, 104 and wants to switch to metal frame rods 102, 104, the user may remove the plastic frame rods 102, 104 from the net apparatus 100 and replace them with the metal frame rods 102, 104.

Interchangeability can provide advantages over the state of the art. First, if one of the frame rods 102, 104 breaks, the user may replace the broken frame rod 102, 104 instead of the entire net apparatus 100. Additionally, there may be times when metal frame rods 102, 104 are preferable over plastic frame rods 102, 104, and vice versa. For example, if a relatively large amount of debris is present at the bottom of a swimming pool, it may be advantageous to use metal frame rods 102, 104, as metal is denser and will allow the net to approach the bottom of the pool more easily. On the other hand, if a lot of floating debris exists, it may be advantageous to use plastic, as plastic is less dense and will allow for easier surface skimming.

The frame rods 102, 104 may have any shape. For example, they may include curves, such as those illustrated in FIG. 1 such that an opening 122 between the frame rods 102, 104 has a rounded shape. In some embodiments, the frame rods 102, 104 can include angles instead of curves, such that the opening 122 includes an angular shape such as a square, parallelogram, hexagon or the like. In some embodiments, the frame rods 102, 104 may include both angles and curves, such that the opening 122 has a combined curved and angular design. In some embodiments, more frame rods may be included than the frame rods 102, 104 and all of the frame rods may be straight. In these embodiments, the net apparatus 100 may include additional connectors which are angled or rounded so as to create an angle between the frame rods.

The frame rods 102, 104 may be solid rods, such as those illustrated in FIG. 1 or they may be hollow structures. The outer surface of the frame rods may be rounded (such that a cross-sectional view would appear circular, oval or the like) or they may be angled (such that a cross-sectional view would appear square, rectangular, triangular, or the like).

The frame rods 102, 104 may be adapted such that they can be coupled to a netting 124. The netting 124 may be attached to the frame rod such that when the frame rods 102, 104 are displaced along an axis that extends through the opening 122, any object that is larger than a hole 126 defined by the netting 124 will be collected by the netting 124. In other words, when the frame rods 102, 104 are displaced along a plane extending through the opening 122, any object that is smaller than the opening 122 will pass through the plane and into the netting 124.

The netting 124 may be coupled to the frame rods 102, 104 in a variety of manners. For example, the netting 124 may include openings along its perimeter such that the openings can slide over and receive the frame rods 102, 104. In some embodiments, the frame rods 102, 104 may be threaded through holes 126 of the netting 124 along the perimeter of the netting 124.

In some embodiments, the netting 124 may include a beveled perimeter material having a shape similar to that of the opening 122. The perimeter may be designed such that it fits over and receives the frame rods 102, 104 and locks in place.

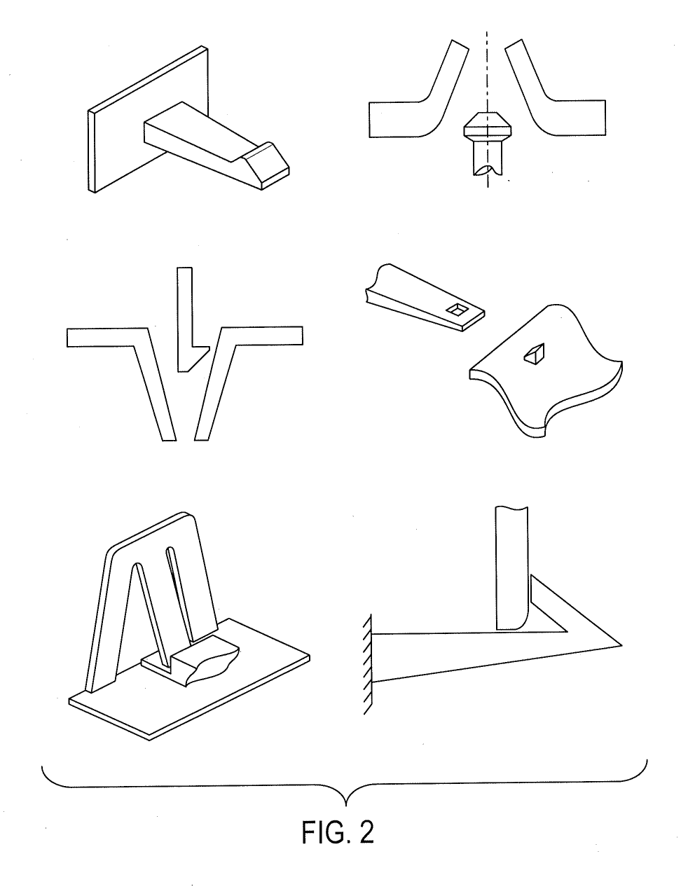

In some embodiments, the netting 124 may include male or female button portions spaced apart along its perimeter. The frame rods 102, 104 may have matching female or male button portions spaced similarly to the button portions on the netting 124. The button portions may attach and secure the netting 124 to the frame rods 102, 104. Instead of button portions, any connection means may be used, such as any snap connectors including but not limited to those illustrated in FIG. 2.

In some embodiments, the netting 124 may include rubber around its perimeter. In these embodiments, the rubber may be stretched so that it fits around the frame rods 102, 104. When placed around the frame rods 102, 104 the rubber may then contract and hold the netting 124 in place.

In some embodiments, the netting 124 may include straps spaced apart along its perimeter such that the straps extend from the netting 124 around the frame rods 102, 104 and attach. For example, a strap may include a first portion having a female button portion and a second portion having a male button portion. In this example, the first portion and the second portion can attach to each other around a frame rod 102, 104 such that the portions are attached to the frame rod 102, 104. The straps may include hook and loop fasteners, such as Velcro®, instead of or in addition to buttons to form the attachment.

The straps may also use snap connectors instead of buttons or hook and loop fasteners in order to attach. FIG. 2 illustrates exemplary snap connectors which may be utilized between the portions of the straps.

In some embodiments, the perimeter of the netting 124 can include extra material having hooks on one side and loops on the other side. In these embodiments, the extra material can wrap around the frame rods 102, 104 and attach using the hook and loop fasteners, such that the netting 124 is attached to the frame rods.

It will be apparent to one in the art that the netting 124 can be attached to the frame rods 102, 104 in any manner and the attachment feature is not limited to the specific attachments discussed herein.

The ability to attach and detach the netting 124, as described herein, is advantageous. Sometimes, only a small amount of debris is present in the pool. In such a situation, a shallower net (i.e., a skimmer) may be preferable to a deeper net (i.e., a pool rake), as the extra netting may be unnecessary and may result in undesirable drag in the water. Occasionally, however, a deep net is preferable, such as when a lot of debris is present in the pool. Situations may also arise where it is preferable to use a net with smaller holes 126, for example, if a lot of fine debris is present in the pool. Other times it may be preferable to use a netting 124 with larger holes 126, for example, if the debris is less fine. The ability to attach and detach the netting 124 allows for use of the net apparatus 100 with a netting 124 that is best suited for any given situation.

Additionally, if a netting 124 breaks, an entirely new net apparatus is unnecessary because a new netting 124 may be used with the remaining structure of the net apparatus 100. Because the netting 124 is detachable, a new netting 124 can be purchased, resulting in repair that may be less expensive than replacement.

The first connector 114 may be made out of metal, plastic, wood or the like. The first connector 114 may be made of a different type of material than the frame rods 102, 104.

The first connector 114 may attach using any means. For example, the first connector may include a socket, such as that illustrated in FIG. 1. The shape of the first connector 114 may be a cylindrical tube.

The first connector 114 is adapted to couple the first and the second frame rods 102, 104 to each other. The first connector 114 can couple the frame rods 102, 104 in a variety of manners. For example, the proximal ends 110, 112 of the frame rods 102, 104 may each include a male portion of a snap connector, such as one illustrated in FIG. 2, and the first connector 114 may include a female portion of the snap connector. The proximal ends 110, 112 of the frame rods 102, 104 may insert into the first connector 114 where they are attached by the snap connector. The connection may remain in place until the snap connector is manually actuated to release the connection. The frame rods 102, 104 may be coupled to the first connector such that the first connector 114 holds the frame rods 102, 104 in place relative to each other.

The first connector 114 may alternately use screws to attach the frame rods 102, 104 together. For example, the proximal end 112 of the second frame rod 104 may include female screw threading and the connector 114 may include a hole 130. The proximal end 112 of the second frame rod 104 may insert into the connector 114 such that the female threading lines up with the hole 130 and a screw is inserted into the connector and attaches the connector to the second frame rod 104. The first frame rod 102 may also include female threading so that a screw can be inserted into the connector through a hole 128 and screw into the female threading of the proximal end 110 of the first frame rod 102.

The frame rods 102, 104 may also attach to the connector 114 using a spring clip. For example, the proximal end 112 of the second frame rod 104 can include a spring clip. When the proximal end 112 of the second frame rod 104 is inserted into the connector 114, a button of the spring clip may enter into the hole 130. In this embodiment, the second frame rod 104 may be attached to the connector 114 until the button is pressed through the hole 130 and the second frame rod 104 is removed from the connector 114. The proximal end 110 of the first frame rod 102 may also include a spring clip that has a button adapted to enter the hole 128.

Alternately, a spring clip may exist within the first connector 114. In this embodiment, when the frame rods 102, 104 are inserted into the first connector 114, a button of the spring clip may push through a hole in the frame rods 102, 104. This button may then enter the holes 130, 128, locking the frame rods 102, 104 in place. When the buttons are depressed through the holes 130, 128, the frame rods 102, 104 may be removed.

In some embodiments, a hole exists through the proximal ends 110, 112 of the frame rods 102, 104. In these embodiments, a pin, such as a spring pin or a split pin, may extend through the holes at the proximal ends 110, 112 of the frame rods 102, 104 and through the holes 128, 130. The pin may then attach the frame rods 102, 104 to the first connector 114.

The first connector 114 is also adapted to attach the frame rods 102, 104 to the pole 116. The first connector 114 may attach to the pole 116 in a variety of manners. For example, the first connector 114 may attach to the pole 116 using screws, snap connectors, spring clips or the like, as described above with reference to the attachment of the frame rods 102, 104 to the connector 114.

In some embodiments, the first connector 114 and the pole 116 may each include holes such that they can be attached using a pin. In some embodiments, the pole 116 and the first connector 114 may include threading, such that the pole 116 may screw into the first connector 114 for attachment. In some embodiments, the first connector 114 may define a cavity for receiving the pole.

Additionally, the manner in which the first connector 114 is attached to the pole 116 may be different from the manner in which the first connector 114 is attached to the frame rods 102, 104. For example, the pole 116 may attach to the first connector 114 using a snap connector, including but not limited to those illustrated in FIG. 2, and the frame rods 102, 104 may attach to the connector 114 using spring clips.

The ability to connect and disconnect the frame rods 102, 104 and the pole 116 from the connector 114 can provide advantages. For example, it allows modularity of frame rods 102, 104. For example, if a user wants to use frame rods 102, 104 that form a larger opening 122, he can simply detach the original frame rods 102, 104 and insert larger frame rods 102, 104.

Additionally, different connectors 114 may be adapted to attach to different sized poles. A user may be able to switch poles by detaching the frame rods 102, 104 from the first connector 114 and attaching them to a connector 114 that is adapted to attach to the new pole.

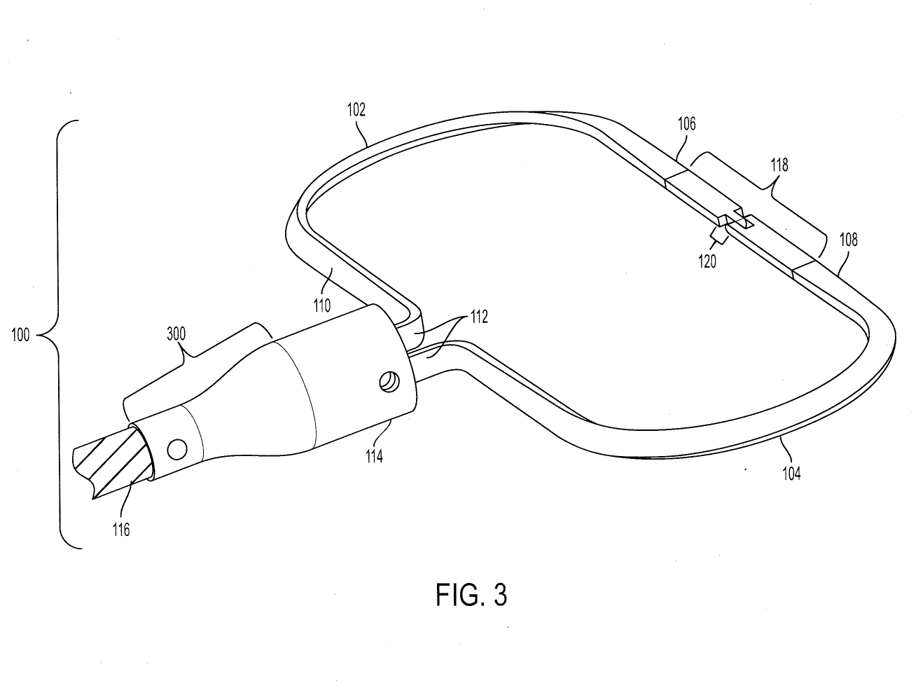

The first connector 114 may also be adapted to attach to poles 116 of different widths. For example, FIG. 3 illustrates an exemplary net apparatus that uses an adaptable first connector 114. As illustrated in FIG. 3, the first connector 114 may include an adapter 300. In some embodiments, the adapter 300 is a sleeve that can be positioned over the first connector 114. In some embodiments, the adapter 300 can attach to the end of the first connector 114.

In some embodiments, the adapter 300 is adapted to attach to a pole 116 of a different diameter than the first connector 114 is adapted to attach to. In some embodiments, the first connector 114 is not adapted to attach to a pole without the adapter 300.

The pole 116 may be adapted to attach to the connector 114 using a first connection means, such as a screw, a snap connector, a spring clip, or the like. Occasionally it may be desirable to swap out the original pole for a pole having a smaller diameter. In such a situation, the adapter 300 may be configured to attach to the pole having the smaller diameter. The adapter 300 may attach to the first connector 114 using the same first connection means. Accordingly, if the pole 116 is adapted to connect to the first connector 114 using a snap connector, then the adapter 300 may connect to the first connector 114 using the snap connector.

Because the adapter 300 is adapted to attach to the pole 116 having the smaller diameter, the adapter 300 allows the pole 116 having the smaller diameter to attach to the connector 114. The adapter 300 may be adapted to attach to the pole 116 using any type of connection, such as screws, snap connectors, spring clips or the like, as described above with reference to the attachment of the pole 116 to the connector 114.

The type of connection between the adapter 300 and the first connector 114 is not required to be the same type of connection as between the adapter 300 and the pole. For example, the adapter 300 may attach to the pole 116 via threading, and the adapter 300 may attach to the connector 114 via snap connectors.

This feature provides an advantage of easier portability and storage. For example, for storage purposes, the adapter 300 can remain attached to the pole 116. Because of the by a relatively minor amount. The adapter 300 may then detach from the first connector 114 such that the net apparatus 100 may be stored separately from the pole 116, thus requiring less space. Because of the connection type between the adapter 300 and the first connector 114, the net apparatus 100 can be quickly and easily reattached to the pole 116 for use via the adapter 300 and the first connector 114.

Referring back to FIG. 1, use of a hinge as the first connector 114 may allow the first and the second frame rods 102, 104 to rotate about each other. For example, the first frame rod 102 may be attached to a first portion of the first connector 114 which may rotate around a center of the first connector 114. The second frame rod 104 may be attached to a second portion of the first connector 114 which may rotate around the center of the first connector independently from the first frame rod 102.

In some embodiments, the first connector 114 may include a mechanism that allows the rotation of the first and second portion to lock and unlock. This mechanism may be any type of mechanism, such as a latch, a spring clip, a lock-pin, or the like. This may be beneficial because it may be desirable for the frame rods 102, 104 to remain in place such that the opening 122 is as large as possible while in use.

These embodiments may allow the first and the second frame rods 102, 104 to rotate towards each other while still attached to the first connector 114 so that the net apparatus 100 requires less space for storage. This may also result in reduced effort for storage, as the frame rods 102, 104 may not require detachment from the first connector 114 in order to reduce in size. As the frame rods 102, 104 may already substantially overlay each other and as the first connector 114 only adds negligible bulk to the net apparatus 100, it may not be necessary for the frame rods 102, 104 to be removable from the first connector 114.

In some embodiments, the pole 116 may be permanently affixed to the first connector 114. In these embodiments, the first and the second frame rods 102, 104 may be removably attached to the first connector 114. For storage, the first and second frame rods 102, 104 may be detached from the first connector 114 and the pole 116 may be stored separately with the first connector 114.

The second connector 118 may be made out of metal, plastic, wood or the like. The second connector 118 does not have to be made of the same type of material as the frame rods 102, 104 or the first connector 114.

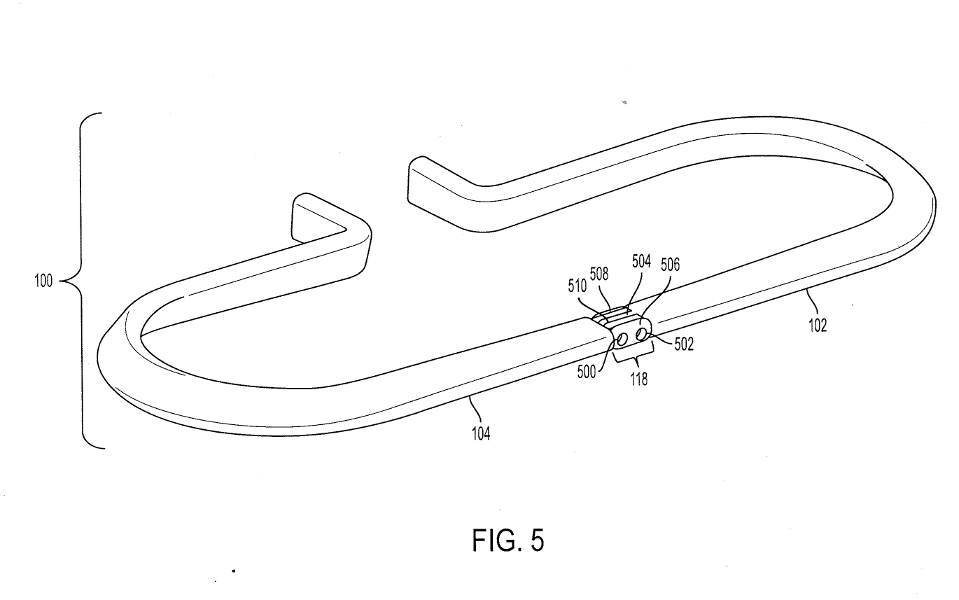

The second connector 118 may be any type of connector. In some embodiments, the second connector 118 may be built onto the frame rods 102, 104 (illustrated in FIG. 5). In these embodiments, the frame rods 102, 104 may connect directly to each other.

In some embodiments, the second connector 118 may attach to the frame rods 102, 104, as illustrated in FIG. 1. The second connector 118 may attach to the frame rods 102, 104 via threading, any snap connectors, including but not limited to those illustrated in FIG. 2, spring clips or the like.

The second connector 118 may include a hinge 120. The hinge 120 may pivotably attach the frame rods 102, 104 to each other. In some embodiments, the hinge 120 may be a knuckle joint such as the joint illustrated in FIG. 1. In these embodiments, the first frame rod 102 (or the second frame rod 104) may include a male hinge portion 132 and the second frame rod 104 (or the first frame rod 102) may include a female hinge portion 134. The male and female hinge portions 132, 134 may connect and attach the frame rods 102, 104 together.

In some embodiments, the male hinge portion 132 may include a protrusion on either side of the outer tip and the female hinge portion 134 may include an indention in the inside of the outer tip. The protrusion may insert into the indention, attaching the hinge portions 132, 134 together. Alternately or additionally, a screw, clipping-rod, or the like may be inserted through a hole in the hinge portions 132, 134, attaching them together.

The second connector 118 may have a mechanism in place that is adapted to prevent or reduce rotation of the hinge 120. This mechanism may retain the frame rods 102, 104 in place so that the opening 122 is as large as possible. For example, this mechanism may include a piece of material placed over the hinge 120 that prevents the hinge connection from rotating. In some embodiments, the second connector 118 may not have any type of locking mechanism, and the frame rods 102, 104 may be held in place relative to each other by the first connector 114.

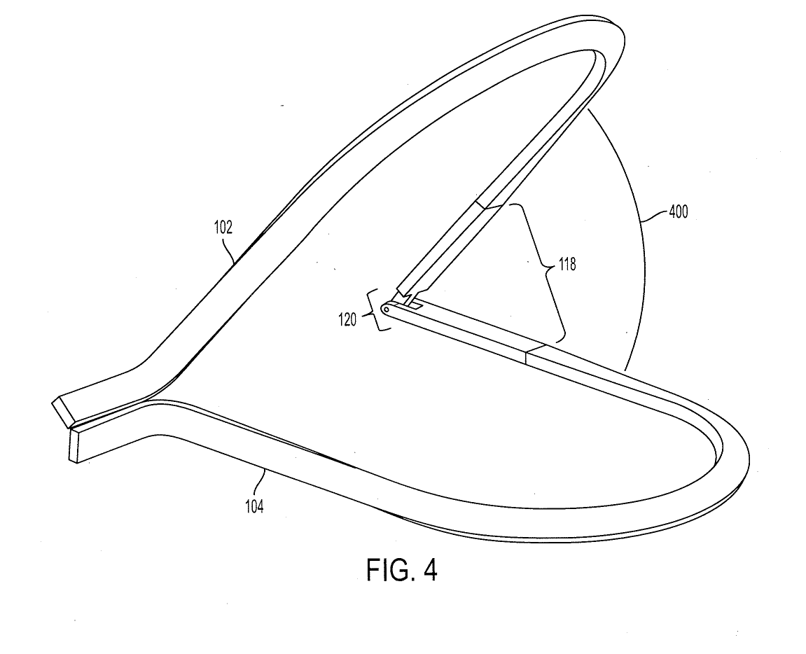

FIG. 4 illustrates an advantage of using a hinge 120 as the second connector 118. In FIG. 4, the first connector 114 is not attached to the frame rods 102, 104. The benefit illustrated by FIG. 4 may also be achieved if the first connector 114 is adapted to allow the frame rods 102, 104 to rotate towards each other.

In FIG. 4, the second connector 118 is a hinge 120. If a locking mechanism for the hinge 120 is provided, it is disengaged in the embodiment illustrated in FIG. 4. As illustrated, the first frame rod 102 and the second frame rod 104 can rotate towards each other about the hinge 120. An angle 400 exists between the frame rods 102, 104. When the net apparatus 100 is to be used, the angle 400 may be between 160 degrees and 200 degrees, such as 180 degrees, so that the opening 122 is as large as possible. However, for storage, the size of the opening 122 is not important.

When rotated towards each other, the frame rods 102, 104 may cause the angle 400 to be less than 180 degrees. The angle may approach 0 degrees so that the frame rods 102, 104 may substantially overlay each other.

This is advantageous as it reduces a total area of the net apparatus 100. The less total area of the net apparatus 100, the easier it is to store the net apparatus 100 because it can be stored in a smaller amount of space. A smaller area of the net apparatus 100 also provides for less expensive shipping options.

FIG. 5 illustrates an embodiment of the net apparatus that utilizes a different hinge 120. The embodiment illustrated in FIG. 5 also utilizes a second connector 118 that is formed on the frame rods 102, 104 instead of attached to the frame rods 102, 104. The second connector 118 in FIG. 5 includes two fingers 504, 506 attached to the first frame rod 102 and two fingers 508, 510 attached to the second frame rod. When attached, the fingers 504, 506, 508, 510 interleave. One, two or more holes 500, 502 may exist through the fingers. A pin may be inserted into the hole(s) 500, 502 in order to attach the frame rods 102, 104 together at the fingers 504, 506, 508, 510.

The pin may be permanently affixed to the second connector 118 or it may be removable. In embodiments where one pin is utilized (inserted into hole 500 or 502), the frame rods 102, 104 may rotate towards each other. This allows the frame rods 102, 104 to substantially overlay each other for ease of storage and shipping. This pin may also be removable so that the frame rods 102, 104 can separate for easier storage or shipping.

In some embodiments, two pins are utilized. In these embodiments, the second connector 118 may remain rigid, such that the frame rods 102, 104 cannot fold towards each other. In these embodiments, one of the pins may be removed such that the frame rods 102, 104 can pivot around the remaining pin. Also, both pins may be removed so that the frame rods 102, 104 can separate for easier storage or shipping.

Returning reference to FIG. 1, the hinge 120 may be a barrel hinge, a pivot hinge, a butt hinge, a case hinge, or any other type of hinge.

In some embodiments, the first frame rod 102 and the second frame rod 104 may attach directly together. They may attach, for example, via screw threading, any snap connectors including but not limited to those illustrated in FIG. 2, spring clips, or the like.

For example, the first frame rod 102 may include one part of a snap connector at the distal end 106 and the second frame rod 104 may include the other part of the snap connector at the distal end 108. In this example, the distal ends 106, 108 may attach via the snap connector.

In some embodiments, the first frame rod 102 may include male screw threading at the distal end 106 and the second frame rod 104 may include female screw threading at the distal end 108. In these embodiments, the distal ends 106, 108 may attach via the screw threading.

In some embodiments, the first frame rod 102 may include a male button part at the distal end 106 and the second frame rod 104 may include a female button part at the distal end 108. In these embodiments, the distal ends 106, 108 may attach via the button.

In some embodiments, one distal end 106, 108 may be adapted to fit inside the other distal end. In these embodiments, the distal ends 106, 108 may be attached by spring clips or similar features.

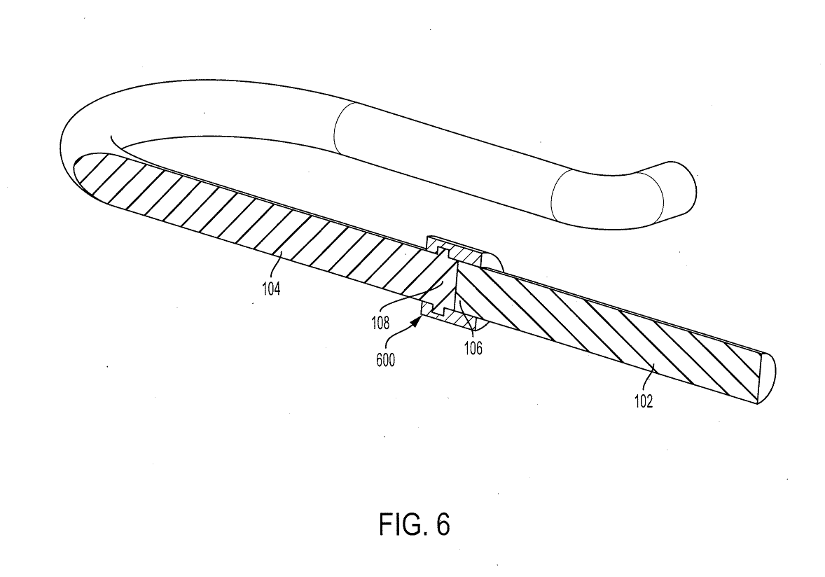

In some embodiments, a hinge 120 may not be included in the second connector 118. FIG. 6 illustrates such an embodiment. In FIG. 6, a cross section of portions of the first frame rod 102, the second frame rod 104 and a bracket 600 are illustrated. In this embodiment, the bracket 600 is used as the second connector 118.

In some embodiments, the bracket 600 may have two portions that snap together using any snap connectors including but not limited to those illustrated in FIG. 2, spring clips or the like. The two portions of the bracket 600 may attach together enclosing the distal ends 106, 108 of the frame rods 102, 104. The inside of the bracket 600 may have the same contours as the distal ends 106, 108 of the frame rods 102, 104. Because of this, the bracket 600, when attached to the distal ends 106, 108, may attach the frame rods 102, 104 together.

In some embodiments, the bracket 600 may have internal threading and the distal ends 106, 108 of the frame rods 102, 104 may have external threading. In these embodiments, the bracket 600 may screw onto the frame rods 102, 104 to form an attachment.

In some embodiments, the distal ends 106, 108 of the frame rods 102, 104 may include female receptors. The bracket 600 may include two male connectors such that each male connector may be received by a corresponding female receptor at the distal ends 106, 108. The male connectors may attach to the female receptors using a snap connector including but not limited to those illustrated in FIG. 2. The male connectors may also attach to the female receptors using a tension fit design. For example, the second connector 118 may be a dowel such that the tension between the dowel and the female receptors attaches the frame rods 102, 104 to the second connector 118. Where used throughout the disclosure, an attachment or connection may refer to a device or system that resists separation of the relative components.

Utilizing a design such as the one illustrated in FIG. 6 provides advantages such as allowing the net apparatus 100 to become less bulky. This is because the frame rods 102, 104 are detachable and thus may be stored in a smaller space. For example, one frame rod 102, 104 may be placed directly on top of the other frame rod 102, 104. The less space required to store the net apparatus 100, the easier the storage is. A less bulky net apparatus 100 also provides for less expensive shipping options.

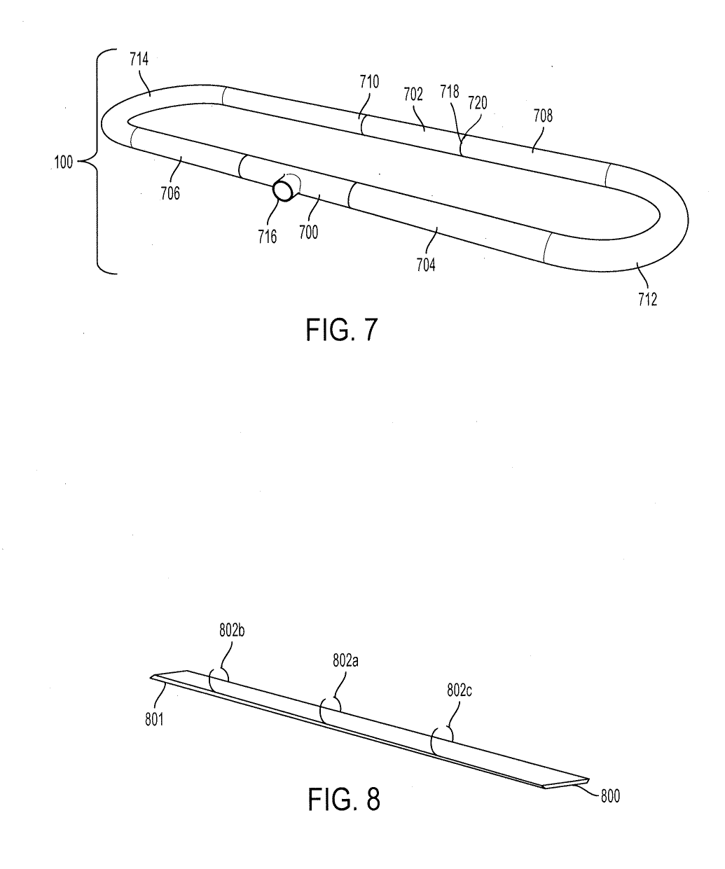

In some embodiments, more than two frame rods 102, 104 may be included with the net apparatus 100. FIG. 7 illustrates an embodiment of the net apparatus 100 that utilizes more than two frame rods. In FIG. 7, 8 frame rods 700, 702, 704, 706, 708, 710, 712 and 714 are utilized. However, the net apparatus 100 may include any quantity of frame rods and is not limited to the embodiments illustrated herein.

In particular, the embodiment of the net apparatus 100 illustrated in FIG. 7 includes a center proximal rod 700, a center distal rod 702, two straight proximal rods 704, 706, two straight distal rods 708, 710 and two curved rods 712, 714.

The center proximal rod 700 may include a connector 716 adapted to attach the pole 116 to the net apparatus 100. In other embodiments, the net apparatus 100 does not include a center proximal rod 700, and instead other rods attach to the first connector 114, as illustrated in FIG. 1. In embodiments such as the one illustrated in FIG. 7, the connector 716 may attach to a pole in any manner. For example, threading, any snap connectors including but not limited to those illustrated in FIG. 2, spring clips or the like may be used to attach the center proximal rod 700 to the pole 116.

The frame rods 700, 702, 704, 706, 708, 710, 712 and 714 may attach together via threading, any snap connectors including but not limited to those illustrated in FIG. 2, spring clips, or the like. For example, the frame rod 708 may have a distal end 720 and the frame rod 702 may have a proximal end 718. The distal end 720 may be hollow and larger than the proximal end 718. The proximal end 718 may fit within the distal end 720. These ends 718, 720 may each have holes (not illustrated) that align. A pin, such as a split pin, may be inserted through the holes, thus connecting the two frame rods 708, 702 together.

In other embodiments, the proximal end 718 may have spring-loaded protrusions on the outside. The distal end 720 may, as in the example above, contain holes. The protrusions may be designed such that when the proximal end 718 is inserted into the distal end 720, the protrusions extend through the holes, thus attaching the frame rods 708, 702 together.

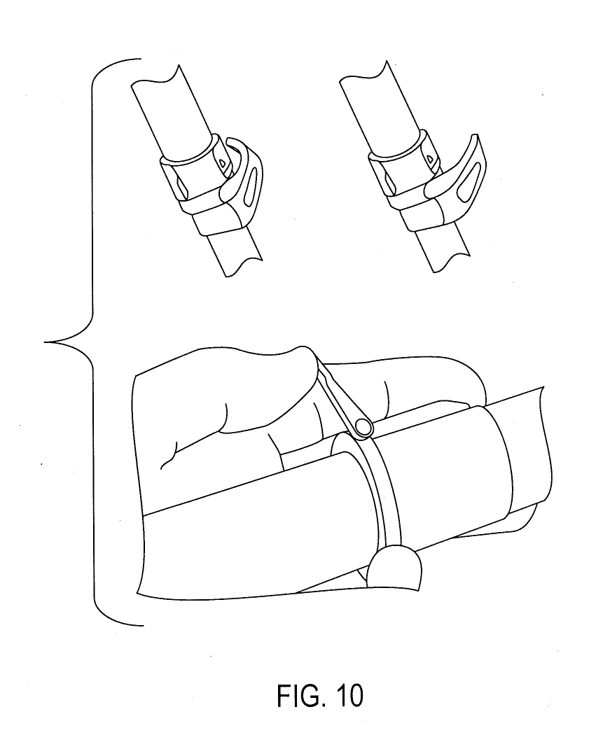

The frame rods 700, 702, 704, 706, 708, 710, 712 and 714 may also attach together via any other locking design such as a camlock, a slide lock, a lever lock, or the like. For example, FIG. 10 illustrates some examples of lever lock designs for attaching two rods together. In some embodiments, the proximal end 718 may be received by the distal end 720. A locking mechanism, such as those mentioned above, may exist that is adapted to attach the two frame rods 708, 702 together. For example, a lever may be depressed when the frame rods 708, 702 are in their correct position in order to secure the frame rods 708, 702 together.

It will be appreciated that any method of attachment discussed herein in regards to any two frame rods, such as frame rods 708, 702, can be applied to any pair of frame rods that are to be attached together.

This modularity provides advantages. The net apparatus 100 may be dismantled (by detaching the frame rods 700, 702, 704, 706, 708, 710, 712 and 714) so that the net apparatus 100 requires less space for storage and may be shipped at a less expensive rate than a net apparatus that is not modular.

Additionally, the ability of the frame rods 700, 702, 704, 706, 708, 710, 712 and 714 to detach allows the user to customize the net for use. For example, if the user wants a larger net apparatus 100, he can add additional frame rods to the frame rods 700, 702, 704, 706, 708, 710, 712 and 714 illustrated in FIG. 7. If the user wants a smaller net apparatus 100, he can remove frame rods, such as frame rods 704, 706, 708 and 710.

Different size nets 100 provide advantages and disadvantages. For example, larger nets 100 can collect more debris per sweep of the pool. However, smaller nets 100 may be easier for a smaller person to manipulate. In these embodiments, nettings 124 having different sized perimeters may be provided so that the user can attach a netting 124 that matches whatever configuration of the net apparatus 100 that the user wants to use.

In some embodiments and referring to FIG. 1, the frame rods 102, 104 may include a beveled edge on the distal ends 106, 108 of the frame rods 102, 104. FIG. 6 may be viewed as one of these embodiments as well, such that the distal ends 106, 108 illustrated are not cross sections, but instead are beveled edges. The beveled edges may allow the net apparatus 100, particularly when adapted to be used as a rake, to collect more debris from a bottom or a side of the pool.

The net apparatus 100 may be provided with rounded frame rods 700, 702, 704, 706, 708, 710, 712 and 714, such as those illustrated in FIG. 7. It may sometimes be preferable to have a beveled edge on the distal ends of the frame rods. FIG. 8 illustrates an attachment 800 adapted to provide this beveled edge to the net apparatus 100.

The attachment 800 may have a flat surface 801 and at least one connector 802. The attachment may have any shape so long as a flat edge exists on a front of the attachment 800.

The connector 802 may be a single connector or multiple connectors 802a, 802b and 802c. The connector may be any type of connector including, but not limited to, the snap connectors illustrated in FIG. 2, buttons, screw threading, pins, spring clips or the like. In the embodiment illustrated in FIG. 8, the connectors 802 are spring clips attached to the attachment 800.

The attachment 800 may attach anywhere on the frame rods 700, 702, 704, 706, 708, 710, 712 and 714. In a preferred embodiment, the attachment 800 is attached to the frame rods 702, 708 and 710 at the front of the net apparatus 100. In preferred embodiments, the attachment 800 is attached at the bottom of the frame rods 702, 708 and 710. This is because the net apparatus 100 may be collecting debris from the bottom of the pool.

When collecting debris from the bottom of the pool, it may be desirable to put downward pressure on the net apparatus 100. Because of the positioning of the attachment 800 at the bottom of the net apparatus 100, pressure will not be exerted in such a way as to dislodge the attachment 800.

The attachment 800 may be adapted to attach to frame rods having different shapes. For example, the attachment 800 may be adapted to attach to triangular frame rods, circular frame rods, rectangular frame rods, or the like.

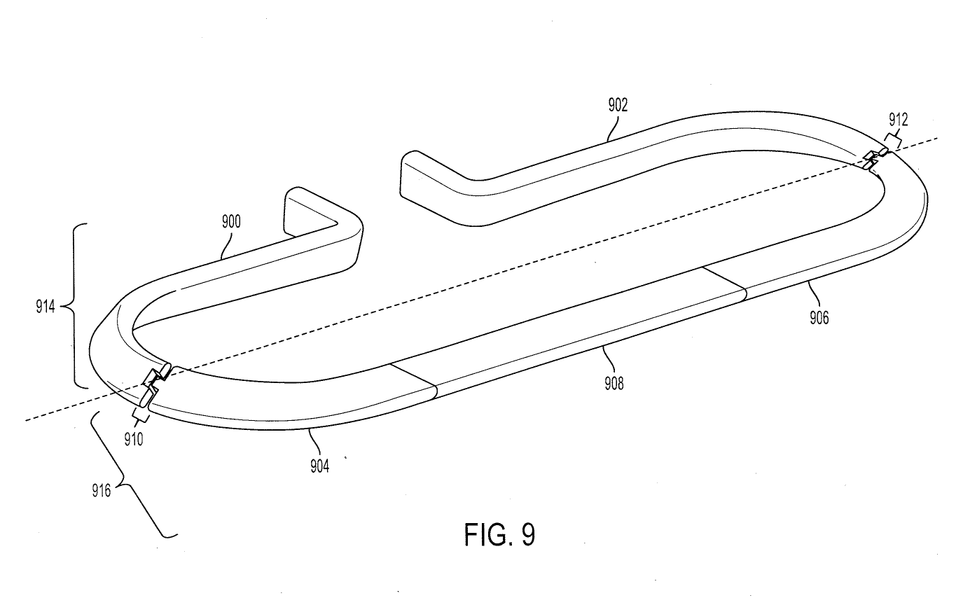

FIG. 9 illustrates another embodiment of a net apparatus. The embodiment illustrated in FIG. 9 includes frame rods 900, 902, 904, 906 and 908. FIG. 2 also includes a first hinge 910 and a second hinge 912. The two hinges 910, 912 may include a locking mechanism adapted to lock the hinges 910, 912 in an extended position.

The embodiment illustrated in FIG. 1 includes the hinge 120 that allows for rotation of the first frame rod 102 towards the second frame rod 104 along an axis extending from the proximal ends 110, 112 of the frame rods 102, 104 towards the hinge 120. The embodiment illustrated in FIG. 9 includes the hinges 910, 912 that allow a proximal half 914 to rotate towards a distal half 916 along an axis that extends from the first hinge 910 towards the second hinge 912.

The locking mechanism allows the hinges 910, 912 to remain in an extended position so that the net apparatus 100 can remain in an open position while in use. The locking mechanism may also unlock so that the net apparatus 100 may become smaller for storage or shipment.

In the embodiment illustrated in FIG. 9, a connector may exist between each frame rod 900, 902, 904, 906 and 908. This connector may be a snap connector including but not limited to those illustrated in FIG. 2, a button, a pin, a spring clip or the like. This allows the net apparatus 100 to be able to be shipped and stored in a smaller package than if the frame rods 900, 902, 904, 906 and 908 were permanently attached.

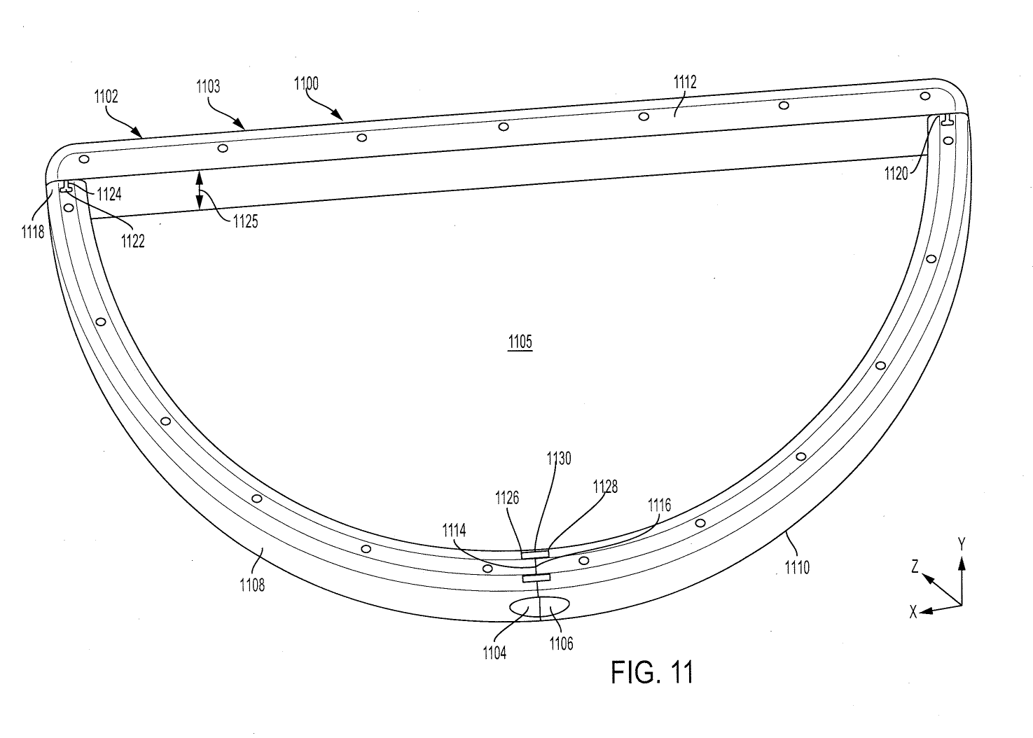

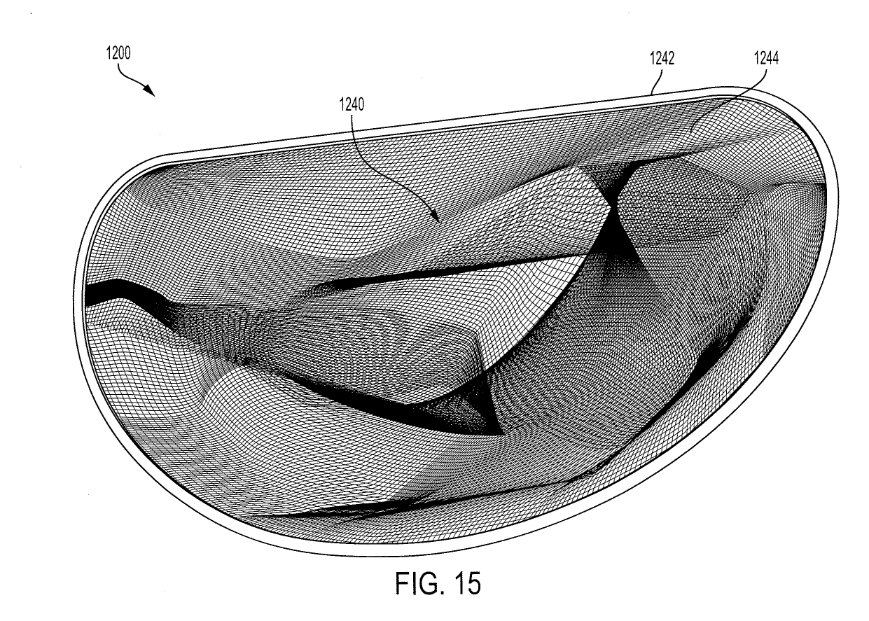

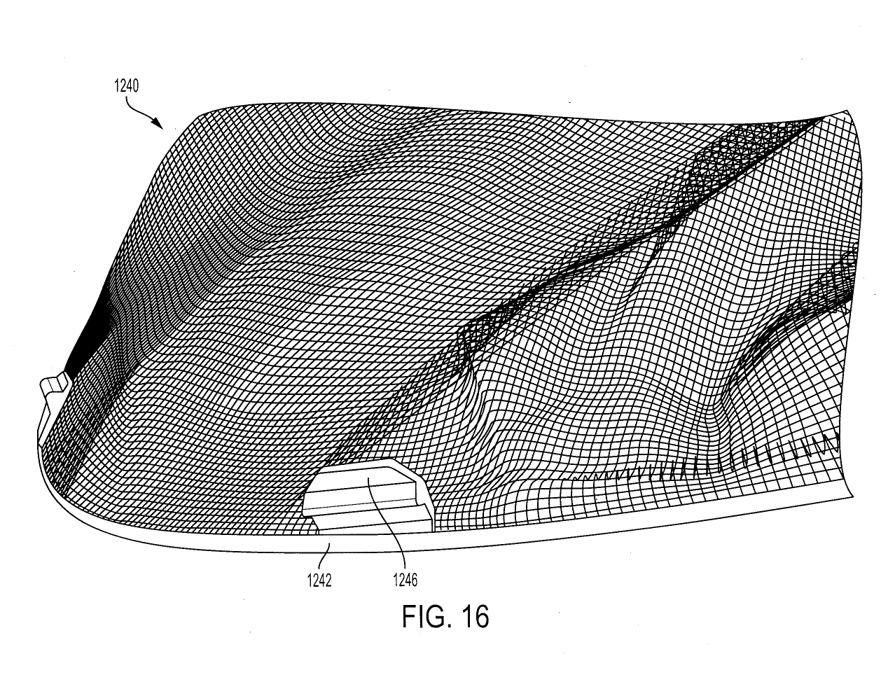

Referring to FIG. 11, another net apparatus 1100 is shown. The apparatus 1100 includes a frame 1102 and is designed to function with a netting, such as the netting 1240 of FIG. 15. The netting may be attached to the frame 1102 in any manner discussed herein.

The frame 1102 includes a plurality of frame rods 1103 and defines an opening 1105 in which the netting may be positioned. The frame rods 1103 define or include a connector 1104 for connection to a pole, such as the pole 116 of FIG. 1. For example, the connector 1104 may include a hole 1106. In some embodiments, the hole 1106 may include threading, a snap connector, or other feature to facilitate a connection between the frame 1102 and the pole.

The plurality of frame rods 1103 includes a first frame rod 1108, a second frame rod 1110, and a third frame rod 1112. Each of the first frame rod 1108 and the second frame rod 1110 may be curved. In some embodiments, the first frame rod 1108 and the second frame rod 1110 may resemble a quarter of a circle. In that regard, the combination of the first frame rod 1108 and the second frame rod 1110 may resemble a semicircle.

The first frame rod 1108 and the second frame rod 1110 may each have a mating end and a second end. In particular, the first frame rod 1108 has a mating end 1114 and a second end 1118. The second frame rod 1110 also includes a mating end 1116 and a second end 1120. The mating ends 1114, 1116 are designed to be removably attached together. In that regard, a frame connector may be used to couple the first frame rod 1108 to the second frame rod 1110.

The first frame rod 1108 may include a first hole 1126 at the mating end 1114, and the second frame rod 1110 may include a second hole 1128 at the mating end 1116. A U-shaped pin 1130 may function as the frame connector and may have one end inserted into the first hole 1126 and a second end inserted into the second hole 1128. The U-shaped pin 1130 may resist separation of the first frame rod 1108 from the second frame rod 1110. Multiple U-shaped pins 1130 may be used between frame rods to increase the stability of the connection between the frame rods.

The third frame rod 1112 may be straight, as shown, or may be curved. For example, the third frame rod 1112 may bow out along the X axis and/or along the Z axis. The third frame rod 1112 may be removably attached to the second end 1118 of the first frame rod 1108 and to the second end 1120 of the second frame rod 1110.

In particular, the third frame rod 1112 may be removably attached to the first frame rod 1108 and the second frame rod 1110 via a tongue and groove feature. In particular, the first frame rod 1108 may include a groove 1124 and the third frame rod 1112 may include a tongue 1122. The tongue 1122 may be received by the groove 1124 and may resist separation of the third frame rod 1112 from the first frame rod 1108. In some embodiments, the tongue 1122 and the groove 1124 may extend along an entire height 1125 of each of the plurality of frame rods 1103. The height 1125 is defined along the Z axis.

In some embodiments, each of the plurality of frame rods 1103 may be coupled together using the same type of feature or using different features, as shown in FIG. 11. In some embodiments, each of the plurality of frame rods 1103 may be coupled together using a tongue and groove feature, a U-shaped pin, a snap connector including but not limited to those illustrated in FIG. 2, or the like.

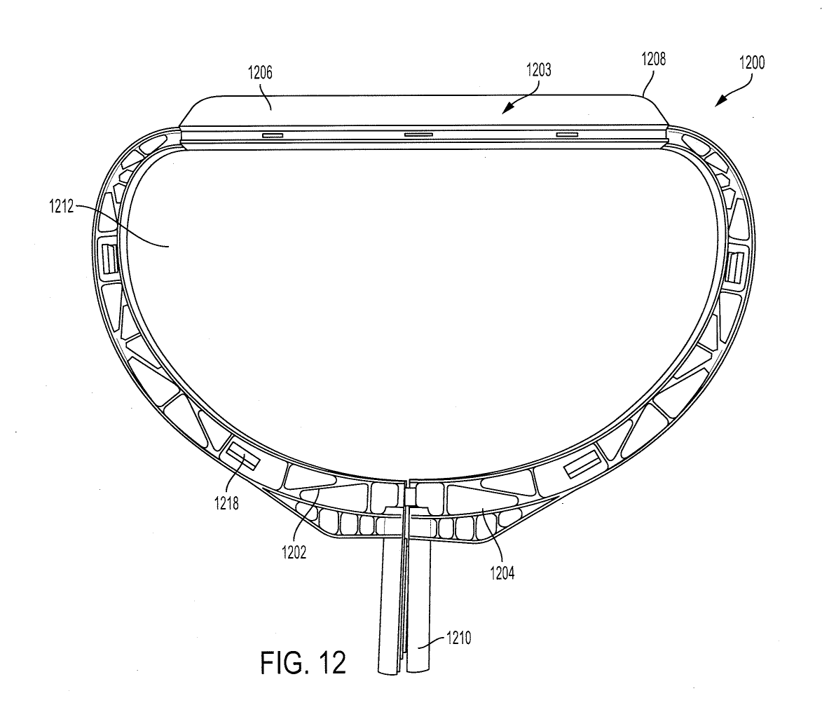

Turning now to FIG. 12, another net apparatus 1200 is shown. The net apparatus 1200 includes a plurality of frame rods 1203 including a first frame rod 1202, a second frame rod 1204, and a third frame rod 1206. Each of the plurality of frame rods 1203 may be removably attached together.

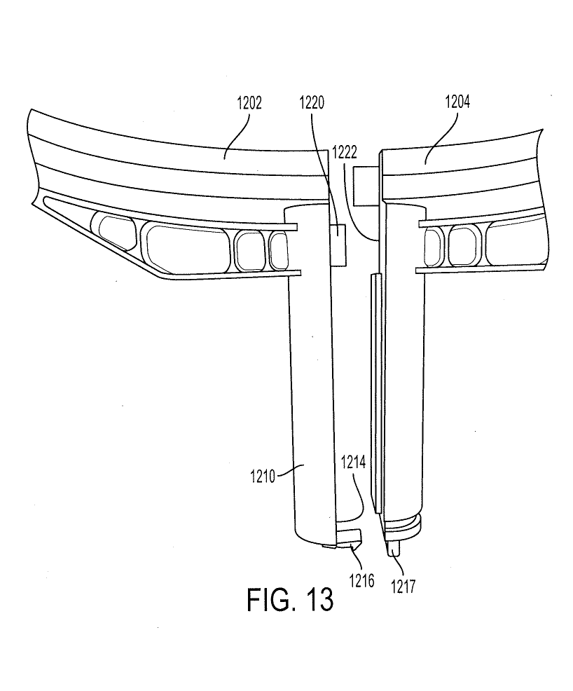

For example and referring to FIG. 13, the first frame rod 1202 may include a tongue 1220 and the second frame rod 1204 may include a groove 1222. The tongue 1220 may be received by the groove 1222 to resist separation of the first frame rod 1202 from the second frame rod 1204. The first frame rod 1202 may further include a snap fit feature 1216 designed to be received by a slot 1217 of the second frame rod 1204. The first frame rod 1202 and the second frame rod 1204 may be removably attached together via the tongue and groove 1220, 1222 and the snap fit feature and slots 1216, 1217.

A cavity 1214 may be defined between the first frame rod 1202 and the second frame rod 1204. The cavity 1214 may be designed to receive a pole, such as the pole 116 of FIG. 1. When the pole 116 is received in the cavity 1214, the connection of the first frame rod 1202 to the second frame rod 1204 may resist separation of the pole from the frame rods 1202, 1204.

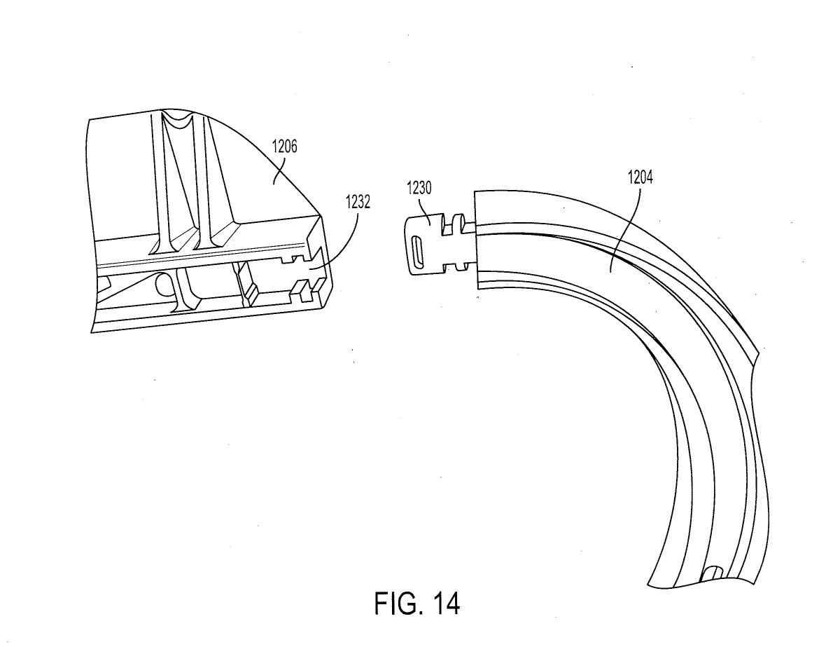

Turning now to FIG. 14, the second frame rod 1204 may be coupled to the third frame rod 1206 via a tongue and groove feature which also functions as a snap connector. As shown, the second frame rod 1204 includes a tongue 1230 and the third frame rod 1206 includes a groove 1232. The tongue 1230 is designed to be received by the groove 1232 and to snap in place when received by the groove 1232.

Referring now to FIGS. 12 and 15, the net apparatus 1200 further includes a netting 1240. The netting 1240 is designed to be removably attached to the plurality of frame rods 1203 and to be at least partially positioned within the opening 1212. The netting 1240 includes a net frame and 1242 and a net 1244. The net frame 1242 is designed to be removably attached to the plurality of frame rods 1203 such that the net 1244 substantially fills the opening 1212.

In particular, the one or more of the plurality of frame rods 1203 may include or define a slot 1218. With reference now to FIGS. 12, 15, and 16, the net frame 1242 may include one or more tabs 1246 that are designed to be received by the slots 1218. The tabs 1246 and the slots 1218 may function together as a snap fit feature. In that regard, the tabs 1246 may snap into the slots 1218 and may be removed from the slots 1218 upon manual actuation of a portion of the tabs 1246. The netting 1240 may be considered to be removably attached to the plurality of frame rods 1203 when the tabs 1246 are received by the slots 1218.

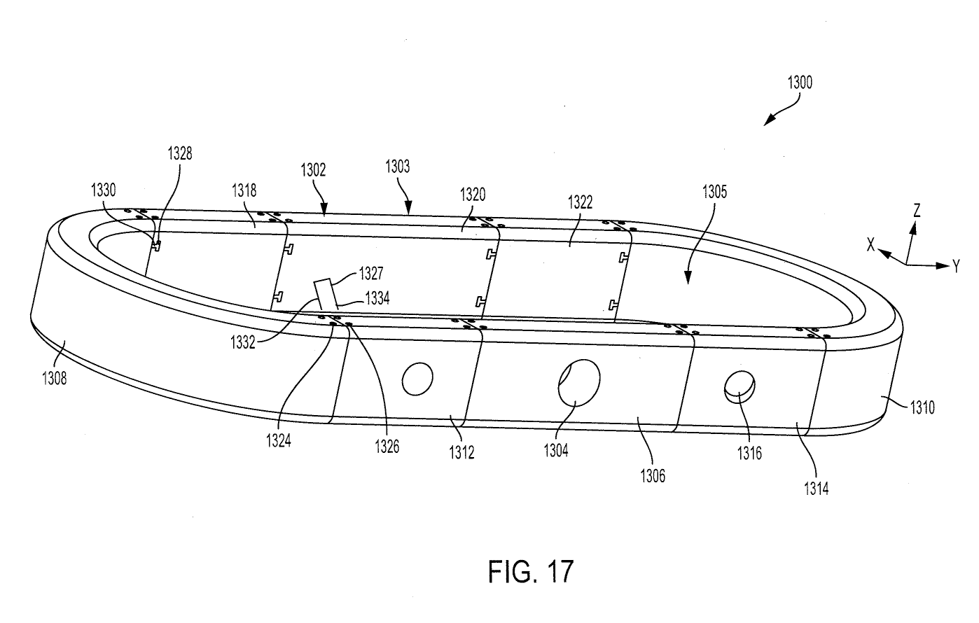

Turning now to FIG. 17 another net apparatus 1300 is shown. The net apparatus 1300 has a frame 1302 that includes a plurality of frame rods 1303. The frame 1302 defines an opening 1305 in which a netting may be positioned. The frame 1302 further includes a pole connector 1304 for connecting the frame 1302 to a pole.

The plurality of frame rods 1303 includes a pole frame rod 1306. The pole frame rod 1306 defines or includes the pole connector 1304. The pole frame rod 1306 may be relatively straight (i.e., extends substantially along the Y axis) or may be curved. The plurality of frame rods 1303 further includes a first end frame rod 1308 and a second end frame rod 1310. The first end frame rod 1308 and the second end frame rod 1310 may be curved. In some embodiments, the first end frame rod 1308 and the second end frame rod 1310 may each have a semicircular shape.

The plurality of frame rods 1303 may further include a first proximal frame rod 1312 and a second proximal frame rod 1314. The first proximal frame rod 1312 and the second proximal frame rod 1314 may be relatively straight or may be curved.

In some embodiments, the first proximal frame rod 1312 and the second proximal frame rod 1314 may each define an auxiliary connector 1316. The auxiliary connectors 1316 may be designed to attach to a pole to provide additional support for the pole. This may be especially desirable if the frame 1302 is designed to be relatively large because use of the three connectors 1304, 1316 attached to the pole may provide sufficient support to move the net apparatus 1300 through water.

The plurality of frame rods 1303 may further include a first distal frame rod 1318, a second distal frame rod 1320, and a third distal frame rod 1322. The first distal frame rod 1318, the second distal frame rod 1320, and the third distal frame rod 1322 may be relatively straight or may be curved.

Each of the plurality of frame rods 1303 may be designed to be removably attached to each of the remaining frame rods 1303. In that regard, the frame 1302 may be modular. For example, the pole frame rod 1306 and the second distal frame rod 1320 may each be removably attached to the first end frame rod 1308 and the second end frame rod 1310. A resulting frame would be smaller in the Y direction than the frame 1302 that includes the proximal frame rods 1312, 1314, the first distal frame rod 1318, and the third distal frame rod 1322. Similarly, if a user desires a larger frame than the frame 1302 then the user may add additional distal frame rods and proximal frame rods.

This modularity is beneficial because it allows a user to utilize net apparatuses with multiple sizes without buying each net apparatus separately. Furthermore, a relatively large net apparatus may be packaged and shipped in a relatively small package.

Each of the plurality of frame rods 1303 may be coupled together in one or more fashion. For example, each of the plurality of frame rods 1303 may be coupled together using a tongue and groove feature along with a frame connector. As shown, each of the plurality of frame rods may include a tongue 1328 and a groove 1330. The tongue 1328 from each frame rod 1303 may be received by the groove 1330 of an adjacent frame rod 1303. In that regard, each of the frame rods 1303 may be removably attached to each of the other frame rods 1303.

Likewise, each of the plurality of frame rods 1303 may include a first hole 1324 and a second hole 1326. A U-shaped pin 1327 may have a first side 1332 that may be received by the first hole 1324 and a second side 1334 that may be received by the second hole 1326. When the U-shaped pin 1327 is received by the holes 1324, 1326, the U-shaped pin 1327 may resist separation of adjacent frame rods 1303. In some embodiments, each of the plurality of frame rods 1303 may include multiple first holes and multiple second holes such that multiple U-shaped pins are utilized to enhance the connection between adjacent frame rods 1303.

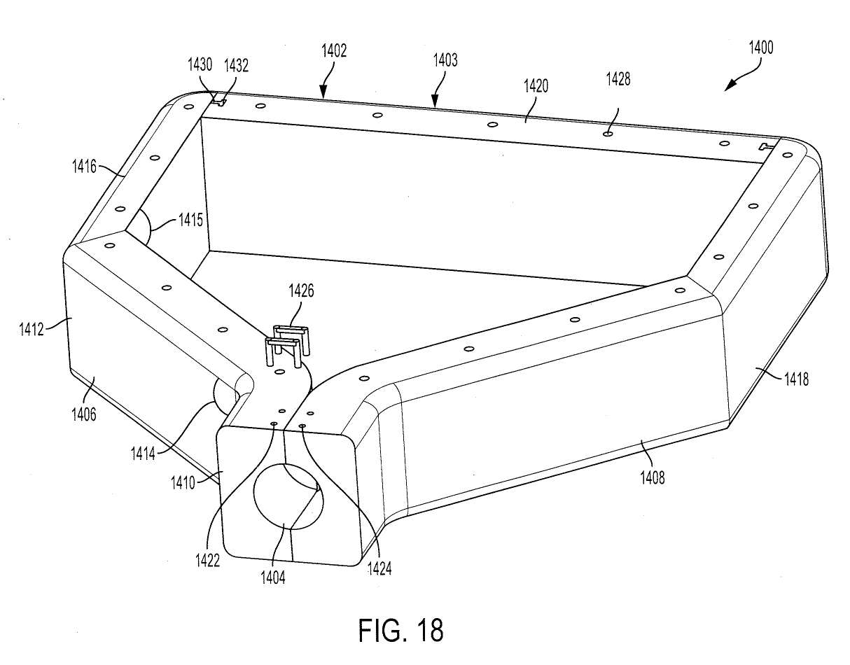

Turning now to FIG. 18, another net apparatus 1400 is shown. The net apparatus 1400 has a frame 1402 that includes a plurality of frame rods 1403. The frame 1402 further includes or defines a connector 1404 for connecting the frame 1402 to a rod.

The plurality of frame rods 1403 includes a first frame rod 1406, a second frame rod 1408, a first side frame rod 1416, a second side frame rod 1418, and a distal frame rod 1420. The first frame rod 1406 and the second frame rod 1408 may each include a parallel portion 1410 and an angled portion 1412. The parallel portions 1410 may be positioned adjacent to each other and may be coupled together, such as via a U-shaped pin 1426 inserted into a first hole 1422 and a second hole 1424. The parallel portions 1410 may further define or include a connector 1404 for connecting the frame 1402 to a pole.

The angled portion 1412 of the first frame rod 1406 and the second frame rod 1408 may extend away from the parallel portion 1410 at an angle 1414. In some embodiments, the angle 1414 may be between 5 degrees and 175 degrees, between 45 degrees and 105 degrees, or the like.

The first side frame rod 1416 may be removably attached to the angled portion 1412 of the first frame rod 1406. The first side frame rod 1416 may form an angle 1415 with the angled portion 1412. In some embodiments, the angle 1415 may be equal to the angle 1414.

The first side frame rod 1416 and the second side frame rod 1418 may be removably attached to the distal frame rod 420. For example, such connection may include a tongue and groove connection including a tongue 1430 and a groove 1432, a U-shaped pin connector, or the like.

The first side frame rod 1416, the second side frame rod 1418, and the distal frame rod 1420 may be straight, as shown, or may be curved.

The frame 1402 may include a plurality of net frame connectors 1428. The net frame connectors 1428 may form a part of a snap fit connector for coupling the frame 1402 to a net frame of a netting.

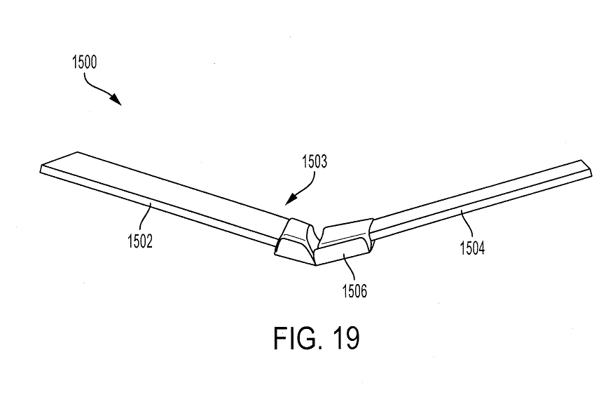

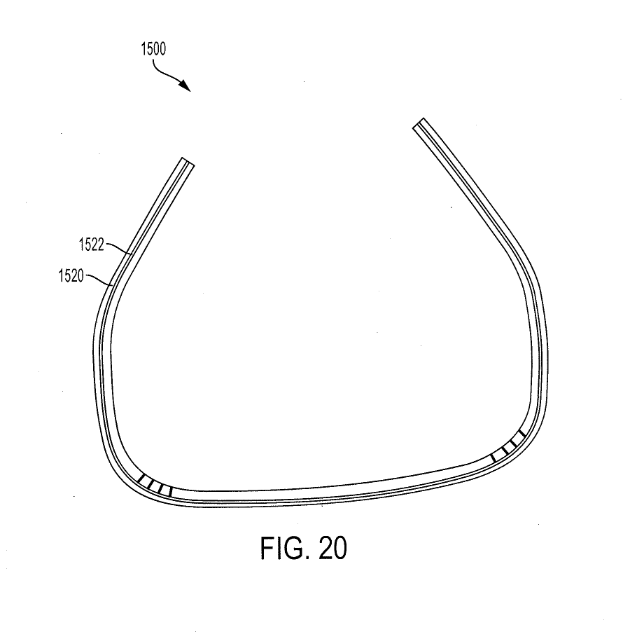

Turning now to FIGS. 19 and 20, another net apparatus 1500 may include a plurality of frame rods 1503. The net apparatus 1500 may include any quantity of frame rods 1503. The net apparatus 1500 may further include a frame connector 1506. The frame connector 1506 may be utilized to connect two frame rods 1503 together. The frame connector 1506 may include any angle, and multiple frame connectors 1506 may be provided with different angles. In that regard, multiple frame rods 1503 and frame connectors 1506 may be utilized to form a frame of a net apparatus.

A net frame 1520 may be made of a malleable material such as a rubber or plastic. The net frame 1520 may define a slot 1522 which may receive a portion or all of the plurality of frame rods 1503. In that regard, a net may be positioned over the plurality of frame rods 1503 prior to insertion of the frame rods 1503 into the slot 1522. The slot 1522 may be designed to resist separation of the plurality of frame rods 1503 from the net frame 1520. In that regard, the design of the slot may further resist separation of the net from the plurality of frame rods 1503 and the net frame 1520.

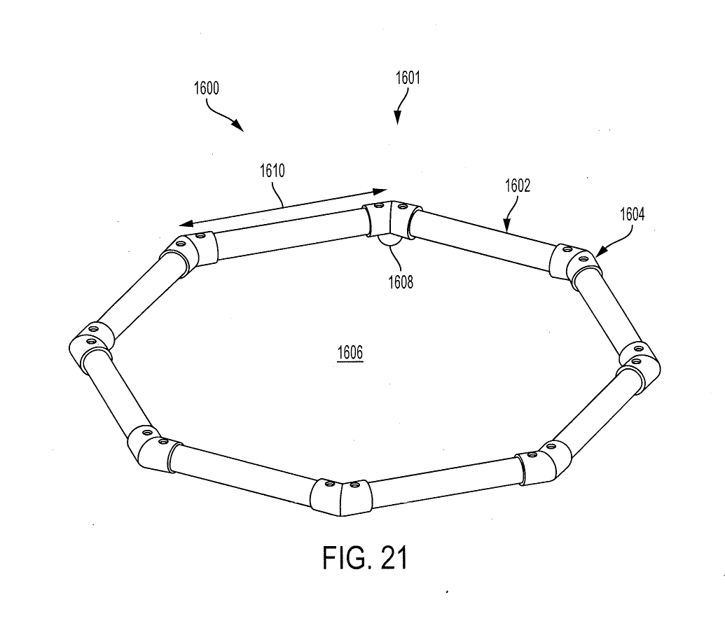

FIG. 21 illustrates a net apparatus 1600 that includes a plurality of frame rods 1602 and a plurality of connectors 1604. The frame rods may each have an equal length 1610. In some embodiments, the length 1610 may be between 2 inches and 10 inches, or between 4 inches and 8 inches, or approximately 4 inches, or approximately 8 inches. Where used in this context approximately refers to the stated value plus or minus 10% of the stated value.

The angled connectors 1604 may each be designed to connect two frame rods 1602 together. Each of the angled connectors 1604 may have an angle 1608. In some embodiments the angle 1608 may be fixed, and in some embodiments the angle 1608 may be variable.

In that regard, multiple frame rods 1602 and multiple angled connectors 1604 may be combined to create a symmetrical frame 1601. The frame 1601 may have any number of sides, each corresponding to one frame rod 1602. For example, the frame 1601 may have 4 sides, 6 sides, 8 sides, 10 sides, 12 sides, or the like.

The diameter of the frame 1601 may be determined based on the quantity of frame rods 1602 and the length 1610 of the frame rods 1602. For example, a frame 1601 with 8 frame rods 1601 and a length 1610 of 4 inches may utilize angled connectors 1604 having an angle 1608 of 135 degrees and may have a diameter of approximately 10.5 inches. As another example, a frame 1601 with 12 frame rods 1601 and a length 1610 of 4 inches may utilize angled connectors 1604 having an angle 1608 of 150 degrees and may have a diameter of approximately 15.5 inches. As yet another example, a frame 1601 with 20 frame rods 1601 and a length 1610 of 4 inches may utilize angled connectors 1604 having an angle 1608 of 162 degrees and may have a diameter of approximately 25.6 inches.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An apparatus for collecting debris, comprising:
a frame having a connector configured to attach to a pole and having:
a plurality of frame rods each configured to be removably connected to at least one other frame rod via a tongue-and-groove feature such that the plurality of frame rods define an opening when connected together; and
a netting configured to be removably connected to the frame and to substantially fill the opening defined by the plurality of frame rods.

2. The apparatus of claim 1 further comprising a U-shaped pin, wherein:
a first frame rod of the plurality of frame rods defines a first hole;
a second frame rod of the plurality of frame rods defines a second hole; and
the U-shaped pin is configured to be received by the first hole and the second hole to resist separation of the first frame rod from the second frame rod.

3. The apparatus of claim 1 wherein the tongue-and-groove feature spans an entire height of each of the plurality of frame rods.

4. The apparatus of claim 1 wherein:
at least some of the plurality of frame rods define a slot;
the netting includes a net frame and a net positioned within the net frame;
the net frame includes a plurality of tabs extending away from the net frame; and
the netting is configured to be removably connected to the frame by inserting the plurality of tabs into the slot of the at least some of the plurality of frame rods.

5. The apparatus of claim 1 wherein the plurality of frame rods includes:
a first frame rod and a second frame rod each having a quarter-circular shape, having mating ends configured to be coupled together and second ends, and defining the connector for the pole between the mating ends; and
a third frame rod configured to be removably connected to the second ends of the first frame rod and the second frame rod such that the frame resembles a semi-circle.

6. The apparatus of claim 1 wherein the plurality of frame rods includes:
a pole frame rod being straight and defining the connector for receiving the pole;
a first end frame rod and a second end frame rod each being curved and having a first end configured to be removably connected to the pole frame rod and a second end; and
at least one distal frame rod configured to be removably connected to the second end of each of the first end frame rod and the second end frame rod.

7. The apparatus of claim 6 wherein:
the plurality of frame rods further includes a first proximal frame rod and a second proximal frame rod each configured to be removably connected between the pole frame rod and one of the first end frame rod or the second end frame rod;
the at least one distal frame rod includes multiple distal frame rods each configured to be removably connected together and including a first distal frame rod configured to be removably connected to the second end of the first end frame rod and a second distal frame rod configured to be removably connected to the second end of the second end frame rod.

8. The apparatus of claim 7 wherein the first proximal frame rod and the second proximal frame rod each define an auxiliary connector for providing additional support for the pole.

9. The apparatus of claim 1 wherein the plurality of frame rods includes:
a first frame rod and a second frame rod each having:
a parallel portion configured to be oriented parallel to each other, to be removably connected together, and together defining the connector for receiving the pole, and
an angled portion extending away from the parallel portion at an angle;
a first side frame rod and a second side frame rod each configured to be removably connected to the angled portion of the first frame rod or the second frame rod and forming the angle with the first frame rod or the second frame rod; and
a distal frame rod having a straight shape and configured to be removably connected to at least one of the first side frame rod or the second side frame rod and to extend from the first side frame rod to the second side frame rod.

10. The apparatus of claim 1 wherein the connector for coupling to the pole includes a hole defined by at least one of the plurality of frame rods.

11. An apparatus to be attached to a pole for removing debris from a swimming pool, the apparatus comprising:
at least two frame rods defining an opening therebetween and including a first frame rod and a second frame rod each having a distal end distal to the pole and a proximal end proximal to the pole;
a first connector adapted to attach the first frame rod and the second frame rod to each other at the proximal end and to attach the first frame rod and the second frame rod to the pole;
a second connector adapted to attach the first frame rod and the second frame rod to each other at the distal end; and
a netting adapted to be coupled to at least one of the first frame rod or the second frame rod.

12. The apparatus of claim 11 wherein the second connector is a hinge configured to pivotably attach the at least two frame rods to each other such that the first frame rod can substantially overlay the second frame rod.

13. The apparatus of claim 11 wherein the second connector includes a bracket configured to be positioned over a portion of the at least two frame rods to connect the at least two frame rods to each other.

14. The apparatus of claim 11 further comprising an attachment configured to attach to at least one of the at least two frame rods and having a flat surface configured to provide a beveled edge to the at least one of the at least two frame rods.

15. The apparatus of claim 11 further comprising an adapter defining a second cavity for receiving a second pole having a smaller diameter than the first pole and configured to be attached to the first connector.

16. The apparatus of claim 11 wherein the first connector includes a cylindrical tube defining a cavity for receiving the pole.

17. An apparatus for collecting debris, comprising:
a frame having a pole connector for coupling to a pole and having a plurality of frame rods each configured to be removably connected to at least one other frame rod such that the plurality of frame rods define an opening when connected together;
at least one frame connector configured to attach at least a first frame rod to at least a second frame rod; and
a netting configured to be removably connected to the frame and to substantially fill the opening defined by the plurality of frame rods.

18. The apparatus of claim 17 wherein:
the at least one frame connector includes a U-shaped pin;
the first frame rod of the plurality of frame rods defines a first hole;
the second frame rod of the plurality of frame rods defines a second hole; and
the U-shaped pin is configured to be received by the first hole and the second hole to resist separation of the first frame rod from the second frame rod.

19. The apparatus of claim 17 wherein:
at least some of the plurality of frame rods define a slot;
the netting includes a net frame and a net positioned within the net frame; the net frame includes a plurality of tabs extending away from the net frame; and
the netting is configured to be removably connected to the frame by inserting the plurality of tabs into the slot of the at least some of the plurality of frame rods.

20. The apparatus of claim 17 wherein the pole connector for coupling to the pole includes a hole defined by at least one of the plurality of frame rods.
